(19) United States
(12) Patent Application Publication
(10) Pub. No.: US 2008/0185258 A1
(43) Pub. Date: Aug. 7, 2008

(54) Cement Mixer Chute Seal System and Method

(76) Inventor: Tullio J. DeCollibus, Laguna Niguel, CA (US)

Correspondence Address: GREENBERG TRAURIG, 3773 HOWARD HUGHES PARKWAY, SUITE 500 NORTH, LAS VEGAS, NV, 89169, US

(21) Appl. No.: 11/850,472

(22) Filed: Sep. 5, 2007

Related U.S. Application Data
(60) Provisional application No. 60/843,302, filed on Sep. 7, 2006.

(51) Int. Cl. B65G 11/18

(52) U.S. Cl. 193/6; 277/608

(57) ABSTRACT

Disclosed is a cement mixer chute assembly designed to seal a cement mixer chute. The cement mixer chute sealing system fits between adjacent sections (e.g., upper and lower) of the cement mixer chute. The cement mixer chute system may be connected to the cement mixer chute in any number of ways including clips, nuts and bolts and adhesives. The cement mixer chute sealing system prevents leakage of wet concrete as it leaves the cement mixer via the cement mixer chute.

### CROSS REFERENCE TO RELATED APPLICATIONS

This application claims the benefit of provisional Application No. 60/843,302 filed Sep. 7, 2006.

### FIELD OF THE INVENTION

The present invention relates in general to a cement mixer chute assembly, and more particularly relates to such a system and method for sealing a cement mixer chute.

### BACKGROUND

This section describes the background of the disclosed embodiment of the present invention. There is no intention, either express or implied, that the background art discussed in this section legally constitutes prior art.

Concrete is frequently delivered to a construction site in a cement mixer truck. The truck may have a rotating drum in which the components of concrete are mixed in route to the site. The concrete is formed by mixing cement and various aggregates, such as sand, with water to form a concrete mixture. At the site, the concrete is poured from the drum onto a surface generally through a chute, which is typically part of the cement mixer truck. The chute is typically made of a number of chute sections connected to one another. The connection points often leak spilling concrete and/or its aggregates onto the ground. The leakage may be environmentally controlled for at least some applications. For example, it may be desirable to prevent or limit the leakage of the concrete and its aggregates onto the ground, as these materials may constitute a serious environmental hazard and require clean up. Further, the leaked materials may constitute lost resources to the concrete provider.

### SUMMARY

A first embodiment of the present invention comprises: a pliable sealing member configured to generally envelope an outer, underneath portion of a cement mixer chute near a connection boundary of adjacent, separate cement mixer chute sections; and means for connecting said pliable sealing member to said cement mixer chute near the connection boundary.

The features of this invention and the manner of attaining them will become apparent, and the invention itself will be best understood by reference to the following description of certain embodiments of the invention taken in conjunction with the accompanying drawings, wherein:

### BRIEF DESCRIPTION OF THE DRAWINGS

FIG. 1 is a side partially cutaway view of a chute sealing system at the connection point of two chute sections in accordance with embodiments of the present invention;

FIG. 2 is an exploded view of one embodiment of the sealing assembly of FIG. 1;

FIG. 3 is a perspective view of the chute sealing system of FIG. 1 with the chute sections unconnected;

FIG. 4 is a cross-sectional view of another embodiment of a sealing assembly; and

FIG. 5 is a detail view of another embodiment of a sealing assembly.

### DETAILED DESCRIPTION

It will be readily understood that the components of the embodiments as generally described and illustrated in the drawings herein, could .be arranged and designed in a wide variety of different configurations. Thus, the following more detailed description of the embodiments of the system, components and method of the present invention, as represented in the drawings, is not intended to limit the scope of the invention, as claimed, but is merely representative of certain embodiments of the invention.

In accordance with certain disclosed embodiments of the present invention, there is provided a system and method for sealing adjacent chute sections of a cement mixer. One embodiment of the disclosed system includes a sealing element and a backing plate attached to a flange on a lower chute section. Another embodiment includes a sealing element and a clip attached to a flange on a lower chute section. Another embodiment of the disclosed method includes installing a sealing element adjacent to a lip of a lower chute section and attaching the lower chute section to an upper chute section wherein the sealing element creates a seal between the lower chute section and the upper chute section.

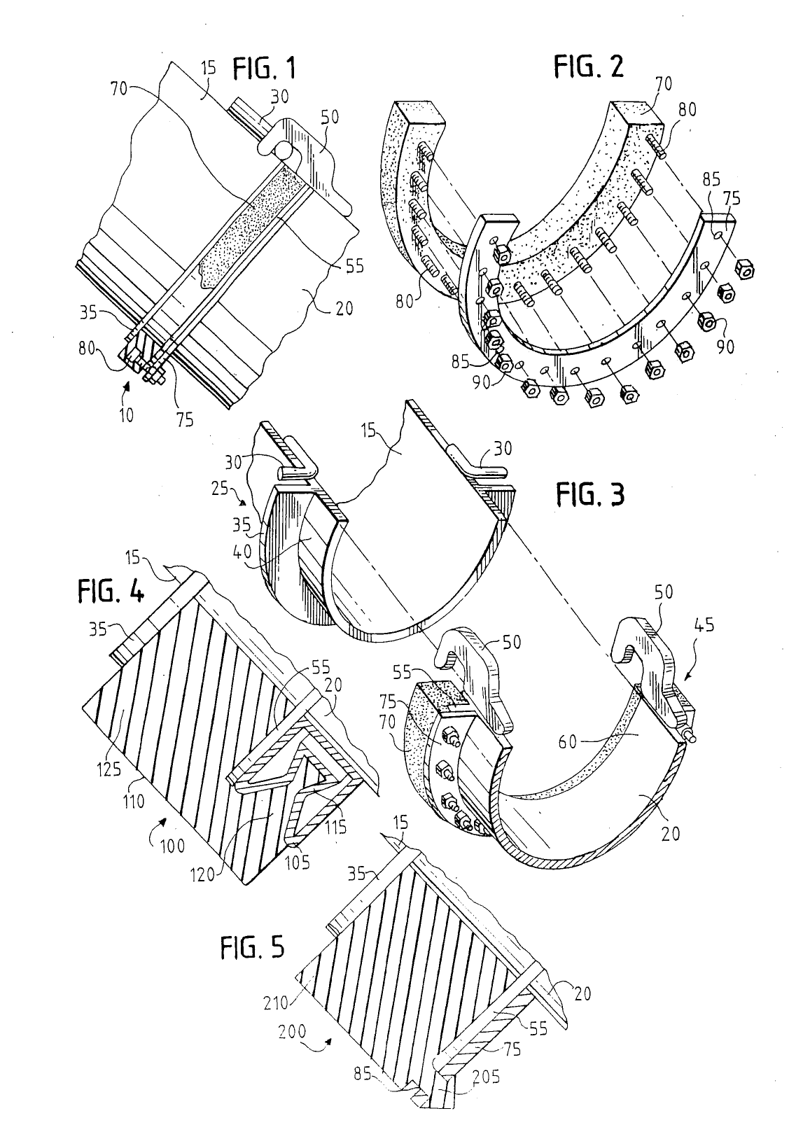

Referring now to the drawings and, more particularly to FIGS. 1 and 3 thereof, there is shown a chute sealing system shown generally at 10, which is constructed in accordance with an embodiment of the invention. The chute sealing system 10 may be part of a chute assembly for a cement mixer.

As shown in FIGS. 1 and 3, the chute assembly may include an upper chute section 15 and a lower chute section 20. Each chute section may be an elongated generally u-shaped member. The upper chute section 15 may include a bottom portion 25 having a pair of pivot pins 30, an abutment flange 35 and a lip 40. The lower chute section 20 may include a top portion 45 having a pair of hooks 50 to engage the pivot pins 30, a flange 55 and a lip 60. The dimension of the lip 60 of the lower chute section 20 may be slightly larger than the dimension of the lip 40 of the upper chute section 15. When the lower chute section 20 is connected to the upper chute section 15, the hooks 50 of the lower chute section 20 may engage the pivot pins 30 of the upper chute section 15, the lip 40 of the upper chute section 15 may be nested in the lip 60 of the lower chute section 20, and the lip 60 of the lower chute section 20 may abut the abutment flange 35 of the upper chute section 15. When connected, the upper chute section 15 and lower chute section 20 create a substantially u-shaped connection or intersection boundary.

Referring now to FIGS. 1 through 3, the chute sealing system 10 is shown. The chute sealing system 10 may include a generally u-shaped sealing element 70 and a. generally u-shaped backing plate 75. The sealing element 70 may be made of gum rubber or some other suitable material by extrusion, casting, or another suitable method. The backing plate 75 may be made of metal or some other suitably durable material. A plurality of bolts 80 may be embedded in the sealing element 70 with a plurality of corresponding holes 85 in backing plate 75.

As shown in FIG. 2, the chute sealing system 10 may be attached to the lower chute section 20 by placing the sealing element 70 over the lip 60 and adjacent the flange 55. The bolts 80 may extend over the flange 55. The backing plate 75 may be placed on the opposite side of flange 55 with bolts 80 extending through holes 85. Nuts 90 may be used with bolts 80 to secure the sealing element 70 and the backing plate 75 to the flange 55 of lower chute section 20. When the lower chute section 20 includes the chute sealing system 10 but is not connected to the upper chute section 15, the sealing element 70 may extend over the end of lip 60 as shown in FIG. 3.

When the lower chute section 20 with the chute sealing system 10 attached is connected to the upper chute section 15, the sealing element 70 creates a seal between the flange 55 and the lip 60 of the lower chute section 20 and the abutment flange 35 of the upper chute section 15.

Referring now to FIG. 4, another embodiment of the chute sealing system is shown. A chute sealing system 100 may include a clip 105 and a sealing element 110. The clip 105 may be generally u-shaped overall and also generally u-shaped in cross-section with a mating cavity 115. The sealing element 110 may be generally u-shaped overall and also generally u-shaped in cross-section with a mating portion 120 and a sealing portion 125.

The clip 105 may be attached to the lower chute section 20 adjacent the flange 55 and opposite the lip 60 with fasteners, adhesives, or any other suitable material or method. The sealing element 110 may be attached to the clip 105 by inserting the mating portion 120 of the sealing element 110 into the mating cavity 115 of the clip 105. With the mating portion 120 inserted into the mating cavity 115, the sealing portion 120 of the sealing element 110 may be located adjacent to the flange 55 and the lip 60 of the lower chute section 20.

When the lower chute section 20, with the chute sealing system 100 attached, is connected to the upper chute section 15, the sealing portion 120 of sealing element 110 creates a seal between the flange 55 and the lip 60 of the lower chute section 20 and the abutment flange 35 of the upper chute section 15.

Referring now to FIG. 5, another embodiment of the chute sealing system is shown. A chute sealing system 200 is very similar to the chute sealing system 10 described above. The bolts 80 and the nuts 90 of chute sealing system 10 may be replaced by a plurality of barbs 205 extending from a sealing element 210. The barbs 205 of sealing element 210 may lock into the holes 85 of the backing plate 75 to attach chute sealing system 200 to the lower chute section 20 in a similar manner as described above for chute sealing system 10.

When the lower chute section 20, with the chute sealing system 200 attached, is connected to the upper chute section 15, the sealing element 210 creates a seal between the flange 55 and the lip 60 of the lower chute section 20 and the abutment flange 35 of the upper chute section 15.

It is also envisioned that a sealing element may be attached to the flange 55 of lower chute section 20 by using an adhesive only. It is further envisioned that the shape of the sealing element and the backing plate may be compatible with chutes of different shapes.

An embodiment of a method of sealing a chute assembly for a cement mixer is described below. A sealing element may be attached to an end of a first chute section that may be adapted to be connected to a second chute section. The sealing element may be shaped in a similar manner as the ends of the chute sections and may extend beyond the end of the first chute section. When the first chute section is attached to the second chute section, the sealing element may create a seal between the two chute sections to eliminate any leakage at this connection point.

While particular embodiments of the present invention have been disclosed, it is to be understood that various different modifications and combinations are possible and are contemplated within the true spirit and scope of the disclosed embodiments. There is no intention, therefore, of limitations to the exact disclosure herein presented.

I claim:

1. A cement mixer chute sealing system comprising:
a pliable sealing member configured to generally envelope an outer, underneath portion of a cement mixer chute near a connection boundary of adjacent, separate cement mixer chute sections; and
means for connecting said pliable sealing member to said cement mixer chute near the connection boundary.

2. The system of claim 1, wherein said sealing member is fabricated of gum rubber.

3. The system of claim 1, further comprising a backing plate to which said sealing member is attachable.

4. The system of claim 3, wherein the sealing member is attached to the backing plate using a series of nuts and bolts.

5. The system of clam 3, wherein the sealing member is attached to the backing plate using adhesive.

6. The system of claim 3, wherein said backing plate has a cross-sectional shape generally matching the sealing member.

7. The system of claim 1, wherein the sealing member has a thickness that causes it to overlap the connection boundary.

8. The system of claim 1, wherein said pliable sealing member is generally u-shaped.

9. A cement mixer chute sealing system comprising:
a sealing member fabricated of a substantially pliable material, said sealing member configured to snugly fit around an outer, underneath periphery of a cement mixer chute;
a backing plate configured for attachment with said sealing member; and
connection means for connecting said sealing member adjacent to an intersection boundary between two cement mixer chute sections.

10. The system of claim 9, wherein said sealing member is fabricated of gum rubber.

11. The system of claim 9, wherein said sealing member has a generally u-shaped cross-section.

12. The system of claim 9, wherein said backing plate has a cross-sectional shape generally matching the sealing member.

13. The system of claim 9, wherein the sealing member has a thickness that causes it to overlap the intersection boundary.

14. The system of claim 9, wherein the sealing member is attached to the backing plate using a series of nuts and bolts.

15. The system of claim 9, wherein the sealing member is attached to the backing plate using adhesive.

16. A cement mixer chute sealing system comprising:
a pliable sealing member configured to generally envelope an outer, underneath portion of a cement mixer chute near a connection boundary of an adjacent, separate cement mixer chute section; and
connecting members configured to connect said pliable sealing member to said cement mixer chute near the connection boundary.

17. The system of claim 16, wherein the connecting members are selected from the group consisting of: adhesives, nuts and bolts, rivets, and clips.

18. A cement mixing chute comprising:
at least two chute sections joinable to one another at respective ends thereof;
a sealing member configured to fit around an outer, underneath surface of said chute sections near a location where the at least two chute sections are joined to one another; and
means for connecting said sealing member to at least one of the chute sections.

19. The cement mixing chute of claim 18, further comprising a backing plate to which said sealing member may be connected.

20. The cement mixing chute of claim 18, wherein the sealing member has a thickness that causes it to overlap the connection boundary.
